(19) United States
(12) Patent Application Publication
(10) Pub. No.: US 2008/0267080 A1
(43) Pub. Date: Oct. 30, 2008

(54) Fault Verification for an Unpaired Unidirectional Switched-Path

(75) Inventors: Robert Sultan, Somers, NY (US); Lucy Yong, Tulsa, OK (US); Linda Dunbar, Plano, TX (US); T. Benjamin Mack-Crane, Downers Grove, IL (US); Deng Zhusheng, Shenzhen (CN); Hao Long, Shenzhen (CN)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/056,405

(22) Filed: Mar. 27, 2008

Related U.S. Application Data
(60) Provisional application No. 60/914,432, filed on Apr. 27, 2007.
(60) Provisional application No. 60/968,809, filed on Aug. 29, 2007.

(51) Int. Cl. G06F 11/00

(52) U.S. Cl. 370/248

(57) ABSTRACT

A communications network comprises a first node and a second node. The communications network further comprises an unpaired switched-path between the first and second nodes. Connectivity of the unpaired switched-path is tested by the first node transmitting a probe message along the unpaired switched-path and waiting to receive a probe message response as connectionless traffic from the second node. Also disclosed is a communications network component comprising logic that selectively verifies connectivity of a unidirectional communication path based on a probe message transmitted as connection-oriented traffic along the unidirectional communication path and a time limit in which to receive a probe message response as connectionless traffic. Also disclosed is a communications network component comprising at least one processor configured to implement a method. The method comprises selectively transmitting a probe message along a unidirectional connection-oriented path and waiting to receive a virtual local area network (VLAN)-based probe message response.

### CROSS-REFERENCE TO RELATED APPLICATIONS

The present application claims priority to U.S. Provisional Patent Application Ser. No. 60/914,432 filed Apr. 27, 2007 by Sultan et al. and entitled “System for Connectivity Fault Management in Networks Supporting Both Connectionless and Connection-Oriented Traffic.” The present application also claims priority to U.S. Provisional Patent Application Ser. No. 60/968,809 filed Aug. 29, 2007 by Sultan et al. and entitled “Fault Verification for an Unpaired Unidirectional Switched-Path.” These provisional applications are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern communication and data networks are comprised of nodes that transport data through the network. The nodes may include routers, switches, and/or bridges that transport the individual data frames and/or packets through the network. Some networks support both connectionless frame transfer (e.g., Provider Backbone Bridging (PBB)) and connection-oriented frame transfer (e.g., PBB Traffic Engineering (PBB-TE)). Further, some connection-oriented networks have unidirectional paths. Providing management services (e.g., Data Communications Network services and/or connectivity fault management) in such networks is desirable.

### SUMMARY

In a first aspect, the disclosure includes a communications network comprising a first node and a second node. The communications network further comprises an unpaired switched-path between the first and second nodes. Connectivity of the unpaired switched-path is tested by the first node transmitting a probe message along the unpaired switched-path and waiting to receive a probe message response as connectionless traffic from the second node.

In a second aspect, the disclosure includes a communications network component comprising logic that supports connection-oriented traffic and connectionless traffic. The logic selectively verifies connectivity of a unidirectional communication path based on a probe message transmitted as connection-oriented traffic along the unidirectional communication path and a time limit in which to receive a probe message response as connectionless traffic.

In a third aspect, the disclosure includes a communications network component comprising at least one processor configured to implement a method. The method comprises supporting connection-oriented traffic and virtual local area network (VLAN)-based connectionless traffic. The method also comprises selectively transmitting a probe message along a unidirectional connection-oriented path and waiting to receive a VLAN-based probe message response.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a protocol diagram of an embodiment of probe and loopback operations.

FIG. 1B is an embodiment of a state machine for the probe and loopback operations of FIG. 1A.

FIG. 2A is a protocol diagram of an embodiment of probe and connectivity check operations.

FIG. 2B is an embodiment of a state machine for the probe and connectivity check operations of FIG. 2A.

FIG. 3 is a block diagram of an embodiment of a network component.

FIG. 4 is a block diagram of an embodiment of a communications network.

FIG. 5 is a block diagram of an embodiment of a general-purpose network component.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As described herein, embodiments of the disclosure involve testing connectivity of unidirectional communication paths in a hybrid networking system that supports connection-oriented traffic and connectionless traffic (e.g., traffic based on VLANs). In some embodiments, connection-oriented frame transfers are based on PBB-TE and connectionless frame transfers are based on PBB. However, the connection-oriented traffic may be associated with any connection-oriented connection or path, such as provider backbone transport (PBT). Likewise, the connectionless traffic is not limited to PBB or VLANs, and includes any type of traffic not associated with a specific connection or path.

The connectivity of a unidirectional communication path (e.g., an unpaired switched-path) can be tested using a probe operation having two parts. The first part involves transmitting a probe message as connection-oriented traffic along the unidirectional communication path to be tested (e.g., from a source node to a target node). The second part involves receiving a probe message response back from a target node as connectionless traffic. In at least some embodiments, an Ethernet Data Communications Network (DCN) is used to transmit probe message responses. For more information on Ethernet DCNs, reference may be had to U.S. Provisional Patent Application Ser. No. 60/970,428 filed Sep. 6, 2007 by Sultan et al. and entitled “Data Communications Network for the Management of an Ethernet Transport Network”, which is herein incorporated by reference.

In at least some embodiments, the probe operation can be combined with a loopback operation or a connectivity check operation that verifies whether connectionless communications between the node issuing the probe message and the node issuing the probe message response are functional. In this manner, a failure to receive a probe message response can be identified as a problem with the unidirectional path or a problem with connectionless communications between the source node and the target node.

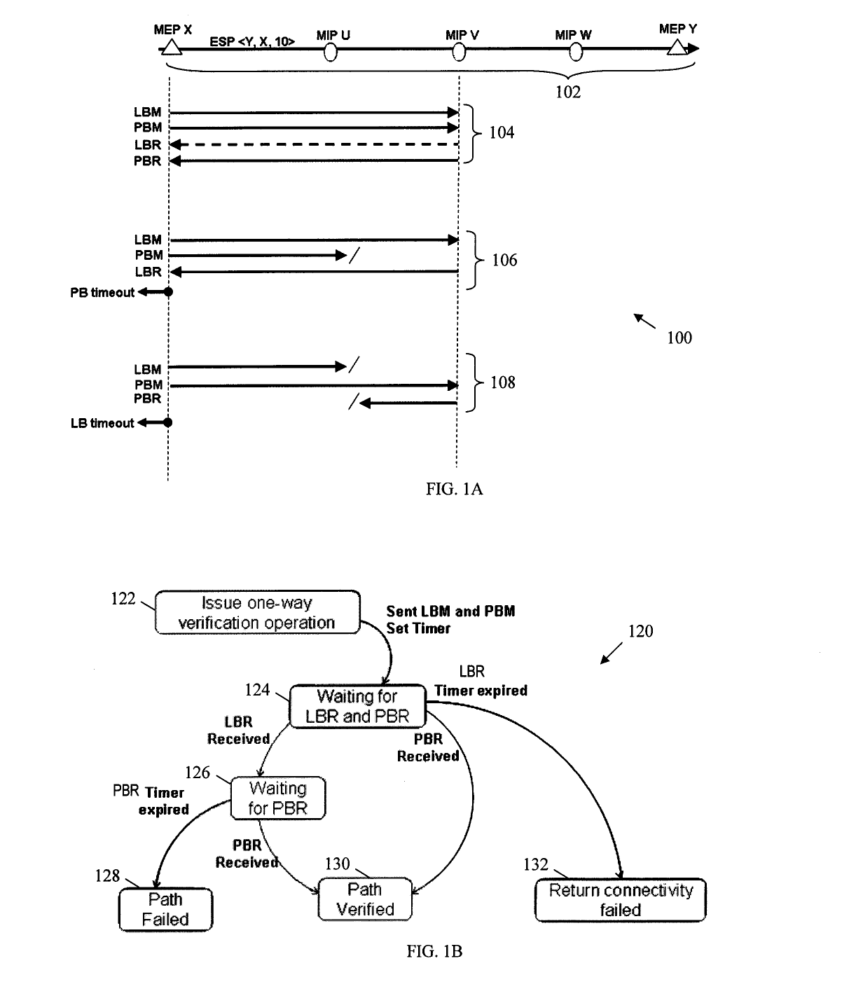

FIG. 1A is a protocol diagram 100 for probe and loopback operations. In FIG. 1A, the probe and loopback operations traverse an Ethernet Switched-Path (ESP) 102. The ESP 102 extends from a source node, X, through several intermediate nodes, U, V, and W, and to a destination node Y. The ESP 102 may be uniquely identified by its destination address, source address, and VLAN identifier (VID). For example, if ESP 102 is associated with VID “10,” then the ESP 102 may be uniquely identified as <Y, X, 10>. Nodes X and Y may be maintenance endpoints (MEPs) and nodes U, V, and W may be maintenance intermediate points (MIPs). For the probe and loopback operations, the source node may be node X and the target node may be node V. In FIG. 1A, probe messages (PBMs) and loopback messages (LBMs) originate from the source node and are directed to the target node along the ESP 102. In contrast, probe message responses (PBRs) and loopback message responses (LBRs) are sent back from the target node to the source node. The LBMs, PBMs, LBRs, and PBRs pass through any intermediate nodes (e.g., MIP U) between the source node and the target node.

In FIG. 1A, various protocols 104, 106, and 108 are shown. In these embodiments, a PBM (connection-oriented traffic) is transmitted from the source node to the target node along the unidirectional path that is to be checked. Similarly, an LBM (connectionless traffic) is sent from the source node to the target node. The LBM and the PBM can be transmitted in any order or at the same time. In at least some embodiments, a timer is associated with each LBM and PBM transmission. For example, a loopback (LB) timer determines if more than a predetermined amount of time passes without receiving an LBR from the target node. Similarly, a probe (PB) timer determines if more than a predetermined amount of time passes without receiving a PBR from the target node. Upon receiving an LBM, the target node is configured to send an LBR to the source node as connectionless traffic (e.g., via the DCN). In some embodiments, the DCN may be a control or management VLAN. Similarly, upon receiving a PBM, the target node is configured to send a PBR to the source node as connectionless traffic (e.g., via a DCN). In Ethernet embodiments, the source node and the target node are identified by Media Access Control (MAC) Address. In such embodiments, the LBM contains the MAC address of the source node and the target node. In addition, in Ethernet embodiments, the DCN can be based on a management VLAN. For more information on management VLANs, reference may be had to U.S. Provisional Patent Application Ser. No. 60/970,428 filed Sep. 6, 2007 by Sultan et al. and entitled “Data Communications Network for the Management of an Ethernet Transport Network.” This provisional application is incorporated herein by reference as if in its entirety.

In at least some embodiments, the procedure for sending the LBM and receiving the LBR corresponds to the Loopback Protocol described in clause 20.2 of IEEE 802.1ag. In such embodiments, the message format and processing associated with the PBR is identical to that of the LBR, except for the value of the message identifier. The PBM differs from the LBM in that the PBM explicitly carries the address of the target node within the body of the PBM and is sent on an unpaired switched-path rather than the DCN.

In FIG. 1A, the protocol 104 illustrates the scenario when the target node successfully returns the LBR and the PBR to the source node. In at least some embodiments, the LBR and the PBR must be received within a predetermined time limit. The time limits for receiving the LBR and the PBR may be the same or different. In the protocol 104, it is assumed that the LBR and the PBR are received within the predetermined time limits. Because the source node successfully receives the PBR in the protocol 104, the source node identifies the state of the unidirectional communication path (e.g., an unpaired switched path or an ESP) as operable. In other words, the source node could not have received the PBR unless the PBM successfully arrived at the target node via an operable communication path, causing the target node to send back the PBR to the source node. In other embodiments, the LBR can be optional as the PBR indicates the connectivity of both the ESP 102 and the return connectivity (e.g., the VLAN).

In contrast, the protocol 106 illustrates the scenario when the target node successfully returns the LBR to the source node, but not the PBR. Because the PBR is not received within a PB time limit, a PB timeout occurs. Based on receiving the LBR within the LBR time limit and based on the PB timeout, the source node identifies the state of the unidirectional communication path as inoperable. In other words, receiving the LBR indicates that connectionless communications between the source node and the target node are functional. Thus, the only other reason for not receiving the PBR is due to the PBM not arriving to the target node (due to an inoperable path).

The protocol 108 illustrates the scenario when the target node does not successfully return either the LBR or the PBR. Because the LBR is not received within an LB time limit, a LB timeout occurs. A PB timeout may also occur. Based on the LB time out and based on not receiving the PBR, the source node identifies the state of the unidirectional communication path as unknown. In other words, the state of the unidirectional communication path cannot be determined because connectionless communications between the source node and the target node are not functional. In order to determine the operability of the unidirectional communication path, connectionless communications need to be established or restored between the source node and the target node.

FIG. 1B is a state machine 120 for the probe and loopback operations of FIG. 1A. The state machine 120 starts by issuing a one-way verification operation at block 122. As shown, the one-way verification operation involves sending an LBM and a PBM. The one-way verification operation also involves setting a timer for each LBM and PBM. At block 124, the state machine 120 waits for the LBR and the PBR. From block 124, if the LB timer expires, the return connectivity fails at block 132. Alternatively, if the LBR is received, the state machine 120 waits for the PBR at block 126. Alternatively, if the PBR is received, the unidirectional path is verified at block 130. From block 126, if the PB timer expires, the unidirectional path fails at block 128. Alternatively, if the PBR is received, the unidirectional path is verified at block 130.

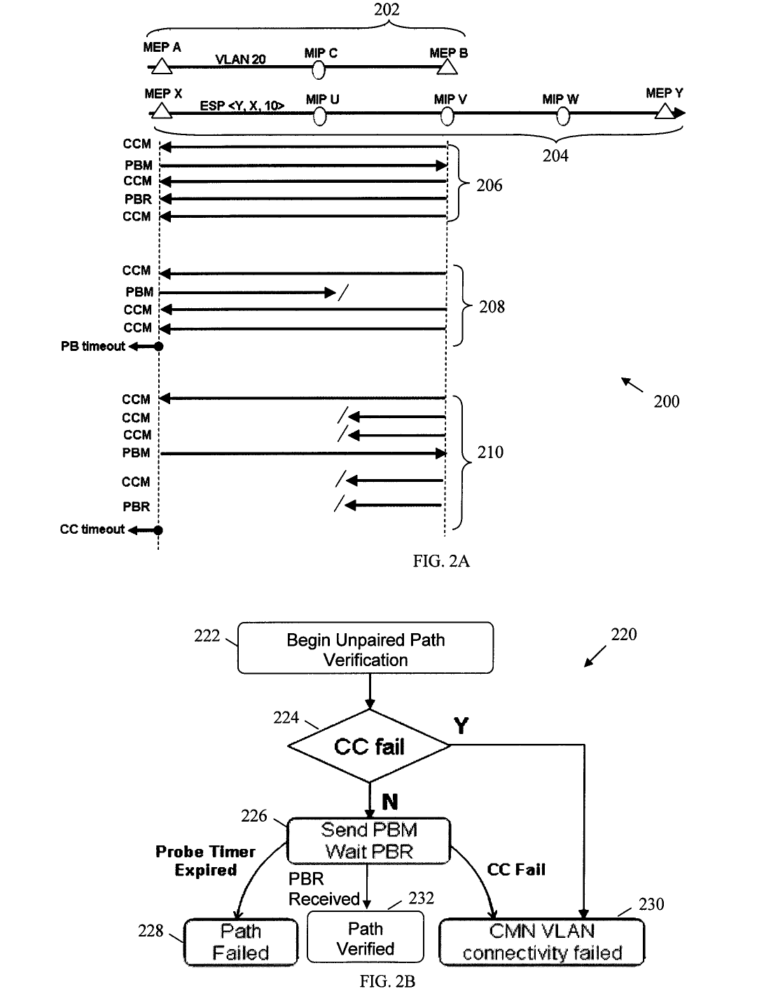

FIG. 2A is a protocol diagram 200 for probe and connectivity check operations. The ESP 204 is substantially similar to the ESP 102 discussed above. Also shown is a VLAN 202 for connectivity check operations. The VLAN 202 passes through node A, which may be a MEP, node C, which may be a MIP, and node B, which may be a MEP. In addition, VLAN 202 is associated with VID “20.” In FIG. 2A, MEP A of the VLAN 202 may reside in the same node as MEP X of the ESP 204. Similarly, MIP C of the VLAN 202 may reside in the same node as MIP U of the ESP 204, and MEP B of the VLAN 202 may reside in the same node as MIP V of the ESP 204.

The connectivity check operation of FIG. 2A can be used in addition to or instead of the loopback operation described in FIGS. 1A and 1B. In accordance with some embodiments, the connectivity checks are in accordance with sections 20.1 and 20.2 of IEEE 802.1ag. To perform the connectivity checks, the target node sends periodic connectivity check messages (CCMs) to the source node. If a connectivity check fails during a probe operation (after the PBM is sent and before the PBR is received), a notification indicating that the probe operation cannot be completed until the connectional traffic (e.g., DCN) fault is repaired may be provided to a network operator.

In FIG. 2A, various protocols 206, 208, and 210 are shown. In all of the protocols, a PBM (connection-oriented traffic) is transmitted from the source node to the target node along the unidirectional path that is to be checked. Upon receiving a PBM, the target node sends a PBR to the source node as connectionless traffic (e.g., via a DCN). As previously explained, a timer tracks whether a PBR is received by the source node within a predetermined time period. Further, in all of the protocols, CCMs are sent periodically by MEP B to MEP A on the VLAN 202 having the VID 20. The CCMs are transmitted such that MEP A will receive a CCM before a PB timeout occurs except when VLAN connectivity between MEP B and MEP A has failed.

In FIG. 2A, the protocol 206 illustrates the scenario where a PBM is sent by the source node (MEP X) to the target node (MIP V) via a unidirectional path (<Y, X, 10>). The PBM is received by the target node and, in response, a PBR is sent by the target node (MEP B) to the source node (MEP A) via VLAN 20. When the PBR is received by source node (MEP A), the connectivity between source node and the target node on unidirectional path <Y, X, 10> is verified. In other words, the source node could not have received the PBR unless the PBM successfully arrived at the target node via an operable communication path. In the protocol 206 CCMs are transmitted, but are not needed to verify the operability of the unidirectional path <Y, X, 10> (only the PBR is needed).

The protocol 208 illustrates the scenario where a PBM is sent by the source node (MEP X) to the target node (MIP V) via the path <Y, X, 10>, but the PBM is not received by the target node. In the protocol 208, a CCM is received by the source node (MEP A) while the probe operation is still pending (before the PB timeout). Thus, it can be inferred that connectivity has failed on path <Y, X, 10> between the source node and the target node. In other words, receiving the CCM indicates that connectionless (VLAN) communications between the source node and the target node are functional. Thus, the only other reason for not receiving the PBR is due to the PBM not arriving to the target node due to a faulty communication path.

The protocol 210 illustrates the scenario where a connectivity check (CC) timeout occurs. A PB timeout may also occur. In some embodiments, if a connectionless communication (e.g., VLAN) failure is detected before the PBM is sent, the PBM is not sent since there is there is a connectivity failure in the path upon which the PBR will be received. Alternatively, if a connectionless communication failure is detected after the PBM is sent, it can be inferred that the PBR cannot be sent from the target node to the source node until connectionless communications are restored. Thus, if a CC timeout occurs, connectionless communications must be established or restored between the source node and the target node in order to determine the operability of a unidirectional communication path between the source node and the target mode.

FIG. 2B is a state machine 220 for the probe and connectivity check operations of FIG. 2A. The state machine 220 starts by beginning an unpaired path verification process at block 222. If a CC failure occurs at block 224, DCN VLAN connectivity is identified as “failed” at block 230. In such case, a PBR does not need to be sent. If a CC failure does not occur at block 224, a PBM is sent and the PBR is waited for at block 226. From block 226, if the PB time limit expires, the unpaired path is identified as “failed” at block 228. Alternatively, if the PBR is received, the unpaired path is identified as “verified” at block 232. Alternatively, if a CC failure occurs after the PBM is sent, the DCN VLAN is identified as “failed” at block 230. Because the DCN VLAN or other connectionless communications are needed to transmit the PBR, failure of such connectionless communications prevent the PBR from being sent from the target node to the source node.

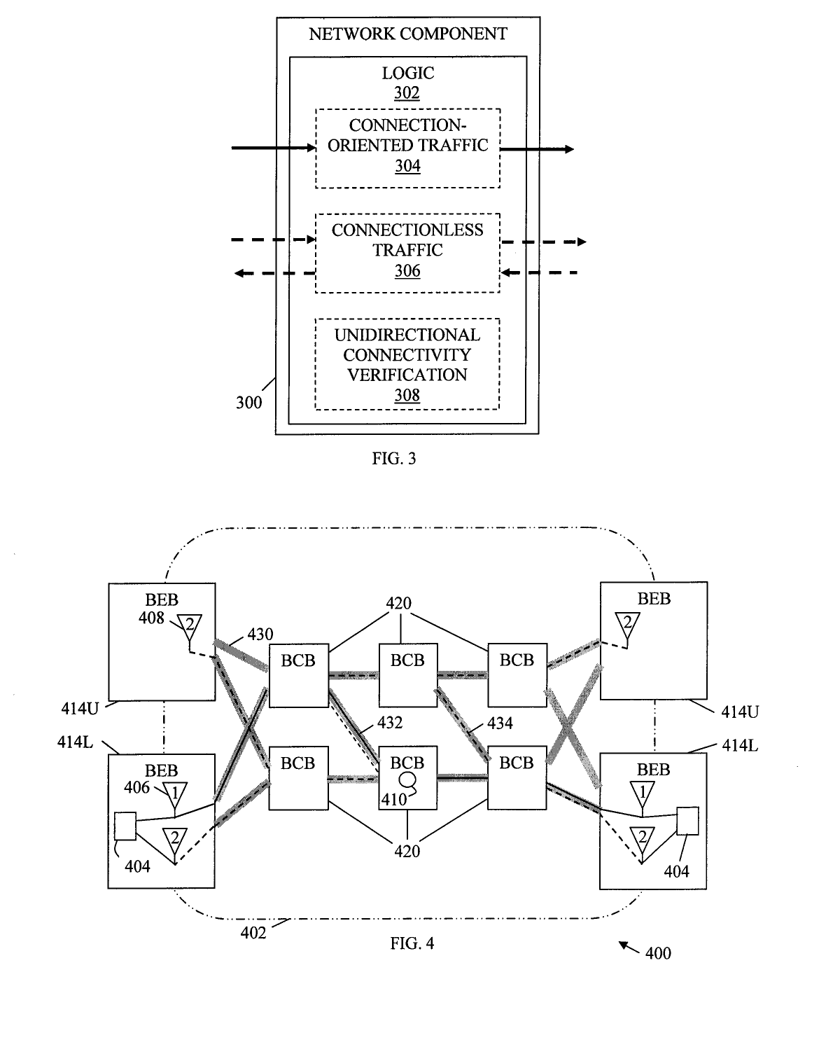

FIG. 3 is a block diagram of an embodiment of a network component 300. In FIG. 3, the network component 300 comprises logic 302 that supports various functions. The logic 302 may be representative of hardware, firmware, and/or software modules as understood by those of skill in the art. As shown, the logic 302 comprises a connection-oriented traffic module 304 that supports unidirectional communications (represented by the solid arrows), and may support connection-oriented unidirectional communications in a plurality of directions, or bi-directional connection-oriented traffic. The logic 302 also comprises a connectionless traffic module 306 that supports VLAN-based communications (represented by the dashed arrows). Finally, the logic 302 comprises a unidirectional connectivity verification module 308 that enables the network component 300 to generate and/or to handle messages related to the probe operation, the loopback operation, and the connectivity check operation described herein.

For example, if the network component 300 is representative of a source node, the unidirectional connectivity verification module 308 may support PBM and LBM generation. In addition, the unidirectional connectivity verification module 308 may implement PB and LB timers as discussed herein. The unidirectional connectivity verification module 308 may also recognize LBRs and PBRs received as connectionless traffic from a target node. Further, the unidirectional connectivity verification module 308 may identify a unidirectional path state as operable, inoperable, or unknown as discussed herein. In alternative embodiments, the unidirectional connectivity verification module 308 supports receiving connectivity check messages (and related timing considerations) in addition to or instead of the loopback operation as discussed herein.

If the network component 300 is representative of a target node, the unidirectional connectivity verification module 308 may be configured to generate PBRs in response to receiving PBMs from a source node. Similarly, the unidirectional connectivity verification module 308 may be configured to generate LBRs in response to receiving LBMs from a source node. In alternative embodiments, the unidirectional connectivity verification module 308 supports generating connectivity check messages in addition to or instead of LBRs.

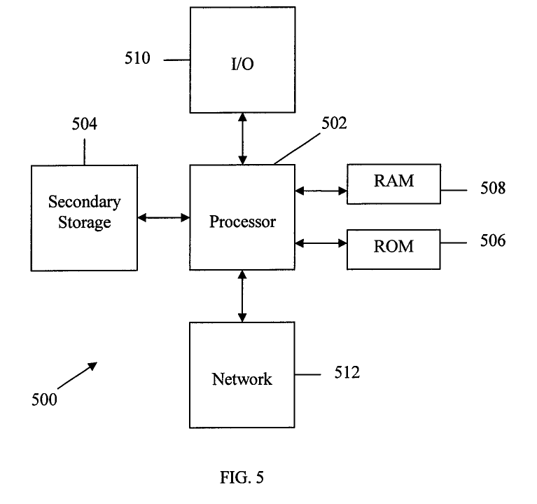

FIG. 4 is a block diagram of an embodiment of a communications network 400. As shown, the communications network comprises a plurality of Backbone Edge Bridges (BEBs) 414 and a plurality of Backbone Core Bridges (BCBs) 420. The various BEBs 414 can support different functions. For example, each upper BEB 414U implements a MEP 408 that originates LBMs on a management VLAN (e.g., a DCN) 434 (represented by the dashed line interconnects). Meanwhile, each lower BEB 414L implements an MEP 408 that originates LBMs on the management VLAN 434 as well as a MEP 406 that originates PBMs on an unpaired switched-path 432 (represented by the solid line interconnects). In some embodiments, the origination of LBMs and PBMs is in accordance with clause 19.2 of IEEE 802.1ag. The LBMs and PBMs can be directed, for example, to one of the BCBs 420 having a target MIP 410.

In accordance with embodiments, LBRs are received by the MEP from which an LBM is sent. However, the probe operation involves the correlation of response messages with request messages. Thus, the MEP 408 associated with the management VLAN 434 and the MEP 406 associated with the unpaired switched-path 432 are configured to share information. In at least some embodiments, the sharing of information is accomplished by associating a coordinator 404 with both MEPs 406 and 408. The coordinator 404 can be associated with additional MEPs as needed. Each MEP reports to the coordinator 404 any information related to the probe operation. In this manner, the coordinator 404 can perform the probe operations described herein on behalf of the distinct MEPs.

The components and methods described above may be implemented on any general-purpose network component, such as a computer, router, switch, or bridge, with sufficient processing power, memory resources, and network throughput capability to handle the necessary workload placed upon it. FIG. 5 illustrates a typical, general-purpose network component suitable for implementing one or more embodiments of a node disclosed herein. The network component 500 includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor may be implemented as one or more CPU chips.

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage 504. The RAM 508 is used to store volatile data and perhaps to store instructions. Access to both ROM 506 and RAM 508 is typically faster than to secondary storage 504.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A communications network, comprising:
a first node;
a second node; and
an unpaired switched-path between the first and second nodes;
wherein connectivity of the unpaired switched-path is tested by the first node transmitting a probe message along the unpaired switched-path and waiting to receive a probe message response as connectionless traffic from the second node.

2. The communications network of claim 1 wherein connectionless traffic connectivity between the first and second nodes is tested based on a separate connectionless message exchange between the first and second nodes.

3. The communications network of claim 2 wherein the connectionless message exchange comprises a loopback operation in accordance with IEEE 802.1ag.

4. The communications network of claim 2 wherein the connectionless message exchange comprises a connectivity check in accordance with IEEE 802.1ag

5. The communications network of claim 1 wherein, the unpaired-switched path is identified as having an operable state when the first node receives the probe message response from the second node.

6. The communications network of claim 2 wherein, the unpaired-switched path is identified as having an inoperable state when the first node does not receive the probe message response within a predetermined amount of time and the connectionless message exchange is successful.

7. The communications network of claim 2 wherein, the unpaired-switched path is identified as having an unknown state when the first node does not receive the probe message response within a predetermined amount of time and the connectionless message exchange is not successful.

8. The communications network of claim 1 wherein the connectionless probe message response is transmitted via an Ethernet data communications network (DCN) associated with a management virtual local area network (VLAN).

9. The communications network of claim 1 wherein the first node comprises a maintenance endpoint (MEP) and the second node comprises a maintenance intermediate point (MIP).

10. A communications network component, comprising:
logic that supports connection-oriented traffic and connectionless traffic;
wherein the logic selectively verifies connectivity of a unidirectional communication path based on a probe message transmitted as connection-oriented traffic along the unidirectional communication path and a time limit in which to receive a probe message response as connectionless traffic.

11. The communications network component of claim 10 wherein the logic selectively generates the probe message and determines if the probe message response is received within the time limit.

12. The communications network component of claim 10 wherein the logic selectively verifies connectionless traffic connectivity based on a separate loopback operation in accordance with IEEE 802.1ag.

13. The communications network component of claim 10 wherein the logic selectively verifies connectionless traffic connectivity based on a separate connectivity check operation in accordance with IEEE 802.1ag.

14. The communications network of claim 10 wherein the logic identifies the unidirectional communication path as having an operable state if the probe message response is received within the time limit.

15. The communications network of claim 10 wherein the logic identifies the unidirectional communication path as having an inoperable state if the probe message response is not received within the time limit and an Ethernet data communications network (DCN) message exchange is successful.

16. The communications network of claim 10 wherein the logic identifies the unidirectional communication path as having an unknown state if the probe message response is not received within the time limit and an Ethernet data communications network (DCN) message exchange is not successful.

17. A communications network component comprising at least one processor configured to implement a method comprising:
supporting connection-oriented traffic and virtual local area network (VLAN)-based connectionless traffic; and
selectively transmitting a probe message along a unidirectional connection-oriented path and waiting to receive a VLAN-based probe message response.

18. The communications network component of claim 17 wherein the method further comprises selectively initiating an operation to test VLAN-based connectivity, the operation being separate from the probe message and the probe message response.

19. The communications network component of claim 18 wherein the method further comprises performing the operation via an Ethernet data communications network (DCN) associated with a management VLAN identifier (VID).

20. The communications network component of claim 18 wherein the method further comprises identifying a state of the unidirectional connection-oriented path as one of operable, inoperable, and unknown based on whether the probe message response is received within a predetermined amount of time and whether the operation is successful.
